(19) United States
(12) Patent Application Publication
(10) Pub. No.: US 2024/0391283 A1
(43) Pub. Date: Nov. 28, 2024

(54) TOP MOUNT JOUNCE CONTROL DAMPER

(71) Applicant: GM GLOBAL TECHNOLOGY OPERATIONS LLC, Detroit, MI (US)

(72) Inventors: Michael APONE, Macomb, MI (US); Douglas Arbour, Brighton, MI (US); Dominck Sterley, White Lake, MI (US)

(21) Appl. No.: 18/324,304

(22) Filed: May 26, 2023

(51) Int. Cl. B60G 15/06; B60G 17/08

(52) U.S. Cl. CPC B60G 15/062; B60G 17/08; B60G 2202/312; B60G 2204/128; B60G 2204/62; B60G 2206/41; B60G 2500/11; B60G 2600/21; B60G 2800/162; B60G 2800/916

(57) ABSTRACT

A shock absorber assembly including: a cylinder housing a first damper fluid and a first piston, the first piston extending out from within the cylinder; a top mount in cooperation with a distal end of the first piston; and a hydraulic jounce control damper adjacent to the top mount, the hydraulic jounce control damper defining a jounce chamber including a second damper fluid and a second piston extending out from within the jounce chamber. In response to compression of the shock absorber assembly, the second piston is configured to contact the cylinder and slide within the jounce chamber with movement of the second piston dampened by the second damper fluid.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a shock absorber assembly including a top mount jounce control damper.

A shock absorber is a mechanical device configured to dampen or absorb shocks and vibrations. It is commonly used in vehicles, for example, to reduce the effects of bumps and vibrations caused by rough roads or other driving conditions. Shock absorbers work by converting kinetic energy (motion) into heat energy, which is then dissipated into the environment. They typically include a piston that moves through hydraulic fluid in a cylinder. When a shock absorber encounters a bump or vibration, the piston moves through the fluid, which provides resistance and slows down movement of a wheel or suspension system. By absorbing and dissipating the energy from shocks and vibrations, shock absorbers help to improve ride comfort, stability, and handling.

### SUMMARY

The present disclosure includes, in various features, a shock absorber assembly including: a cylinder housing a first damper fluid and a first piston, the first piston extending out from within the cylinder; a top mount in cooperation with a distal end of the first piston; and a hydraulic jounce control damper adjacent to the top mount, the hydraulic jounce control damper defining a jounce chamber including a second damper fluid and a second piston extending out from within the jounce chamber. In response to compression of the shock absorber assembly, the second piston is configured to contact the cylinder and slide within the jounce chamber with movement of the second piston dampened by the second damper fluid.

In further features, the shock absorber assembly is configured for installation in a vehicle.

In further features, a spring extends around the hydraulic jounce control damper, the first piston, and the cylinder.

In further features, the second piston defines valve openings configured to allow the second damper fluid to flow therethrough.

In further features, the jounce chamber is annular and extends around the first piston.

In further features, the jounce chamber further includes a third piston slidably movable within the jounce chamber between the second piston and a top end of the jounce chamber.

In further features, the second damper fluid is within the jounce chamber between the second piston and the third piston; and a third damper fluid is between the third piston and the top end of the jounce chamber.

In further features, the second damper fluid is a hydraulic fluid and the third damper fluid is a gas.

In further features, as the second piston slides within the jounce chamber in response to compression of the shock absorber assembly, the second piston pushes the second damper fluid against the third piston and moves the third piston towards the top end of the jounce chamber, movement of the third piston is dampened by the third damper fluid.

In further features, the third damper fluid is nitrogen gas.

In further features, the third piston is configured to restrict flow of the second damper fluid and the third damper fluid across the third piston.

The present disclosure further includes, in various features, a shock absorber assembly including: a cylinder housing a first damper fluid and a first piston, the first piston extending out from within the cylinder; a top mount in cooperation with a distal end of the first piston; a hydraulic jounce control damper adjacent to the top mount and surrounding the first piston, the hydraulic jounce control damper defining a jounce chamber including a second piston extending out from within the jounce chamber and a third piston between the second piston and a top end of the jounce chamber, a hydraulic fluid is between the second piston and the third piston, and nitrogen gas is between the second piston and the top end of the jounce chamber; and a spring extending around the hydraulic jounce control damper, the first piston, and the cylinder. In response to compression of the shock absorber assembly, the second piston is configured to contact the cylinder and slide within the jounce chamber to push the hydraulic fluid against the third piston to move the third piston towards the top end. Movement of the second piston is dampened by the hydraulic fluid and movement of the third piston is dampened by the nitrogen gas.

In further features, the shock absorber assembly is configured for installation in a vehicle.

In further features, the second piston includes valve openings configured to allow the hydraulic fluid to flow therethrough.

In further features, each one of the jounce chamber, the second piston, and the third piston are annular-shaped and extend around the first piston.

The present disclosure also includes, in various features, a shock absorber assembly including: a cylinder housing a first damper fluid and a first piston, the first piston extending out from within the cylinder; a top mount in cooperation with a distal end of the first piston; and a jounce control damper adjacent to the top mount. The jounce control damper includes: a housing defining a jounce chamber; a second piston including a flange within the jounce chamber and a stem extending from the flange to an exterior of the jounce chamber, the flange defining a plurality of valves extending therethrough; a third piston within the jounce chamber between the second piston and a top end of the jounce chamber; a second damper fluid within a first area of the jounce chamber defined between the flange of second piston and the third piston; and a third damper fluid within a second area of the jounce chamber defined between the third piston and the top end of the jounce chamber. In a relaxed configuration of the jounce control damper, the flange of the second piston is seated on a bottom of the jounce chamber; and in a compressed configuration of the jounce control damper, the flange of the second piston has slid towards the third piston to push the first damper fluid against the third piston and move the third piston towards the top end of the jounce chamber, and the second damper fluid flows through the plurality of valves of the flange into a third area of the jounce chamber defined between the flange of the second piston and the bottom of the jounce chamber.

In further features, the second damper fluid is hydraulic fluid and the third damper fluid is nitrogen gas.

In further features, the shock absorber assembly is configured for installation in a vehicle.

In further features, a spring extends around the jounce control damper, the first piston, and the cylinder.

In further features, each one of the jounce chamber, the second piston, and the third piston are annular-shaped and extend around the first piston.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of a shock absorber assembly including a hydraulic jounce control damper in accordance with the present disclosure;

FIG. 2 is a cross-sectional view of FIG. 1;

FIG. 3 is a cross-sectional view of the hydraulic jounce control damper in a relaxed configuration; and

FIG. 4 is a cross-sectional view of the hydraulic jounce control damper in a compressed configuration.

In the drawings, reference numbers may be reused to identify similar and/or identical elements.

### DETAILED DESCRIPTION

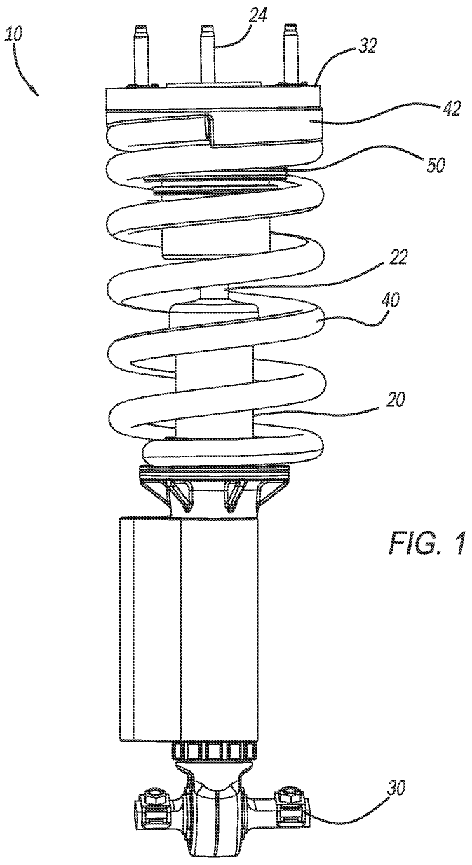

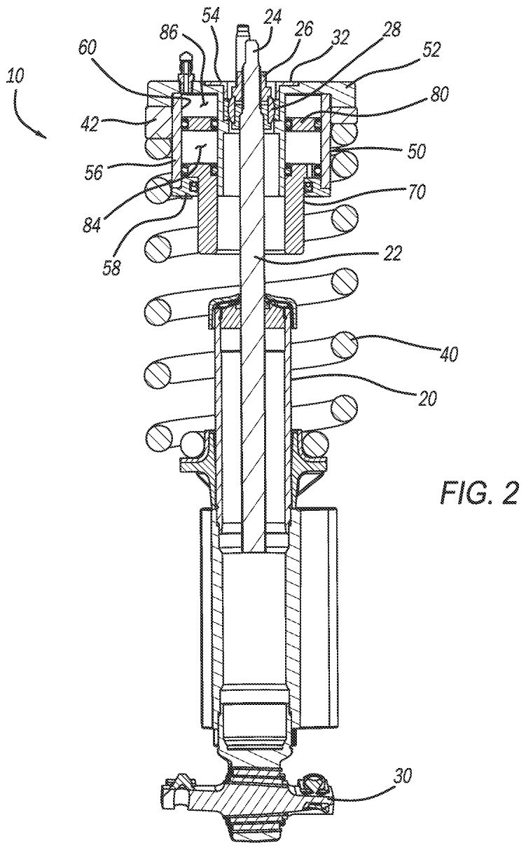

FIGS. 1 and 2 illustrate an exemplary shock absorber assembly 10 in accordance with the present disclosure. The shock absorber assembly 10 is configured to absorb and dampen the impact of shocks and vibrations. The shock absorber assembly 10 may be used in any suitable application. For example, the shock absorber assembly 10 may be configured for installation in a vehicle to absorb and dampen the impact of shocks and vibrations caused by the vehicle traveling over an uneven road. The shock absorber assembly 10 is configured to help prevent the vehicle from bouncing excessively, and also helps to reduce stress and wear on the suspension system and vehicle tires. The shock absorber assembly 10 may be configured for use in any suitable non-vehicular application as well.

The shock absorber assembly 10 generally includes a cylinder 20 housing a damper fluid and a piston 22. The piston 22 extends from the cylinder 20. A distal end 24 of the piston 22 is at a top end of the shock absorber assembly 10. The damper fluid dampens movement of the piston 22. The damper fluid may be any suitable hydraulic fluid, such as any suitable hydraulic oil, for example.

The shock absorber assembly 10 includes a bottom mount 30 and a top mount 32 at opposite ends of the shock absorber assembly 10. The bottom mount 30 and the top mount 32 are configured in any suitable manner for mounting the shock absorber assembly 10 to a vehicle suspension system, or at any other suitable location where dampening of shocks and vibrations is needed. The shock absorber assembly 10 further includes a spring 40, which extends from a spring isolator 42 approximate to the top mount 32 to a mount at the cylinder 20. The spring 40 surrounds the cylinder 20, the piston 22, and a jounce control damper 50.

The jounce control damper 50 is a hydraulic jounce control damper adjacent to the top mount 32. The piston 22 extends through the jounce control damper 50 and is fastened to a cup cap 52 by nuts 26 and a spherical bearing 28 between the nuts 26 and the cup cap 52. A bushing cover 54 is seated over the piston 22 and the nuts 26.

Extending from the cup cap 52 is a housing cup 56. At a bottom end of the housing cup 56 is a bottom cap 58. A jounce chamber 60 is defined by the cup cap 52, the housing cup 56, and a bottom cap 58. More specifically, in the example illustrated the cup cap 52 defines a top end of the jounce chamber 60, the housing cup provides a side wall of the jounce chamber 60, and the bottom cap 58 defines a bottom end of the jounce chamber 60. The jounce chamber 60 is generally an annular chamber surrounding the piston 22. An inner wall of the jounce chamber 60 is defined by a center flange of the cup cap 52. The piston 22 extends through the center flange of the cup cap 52.

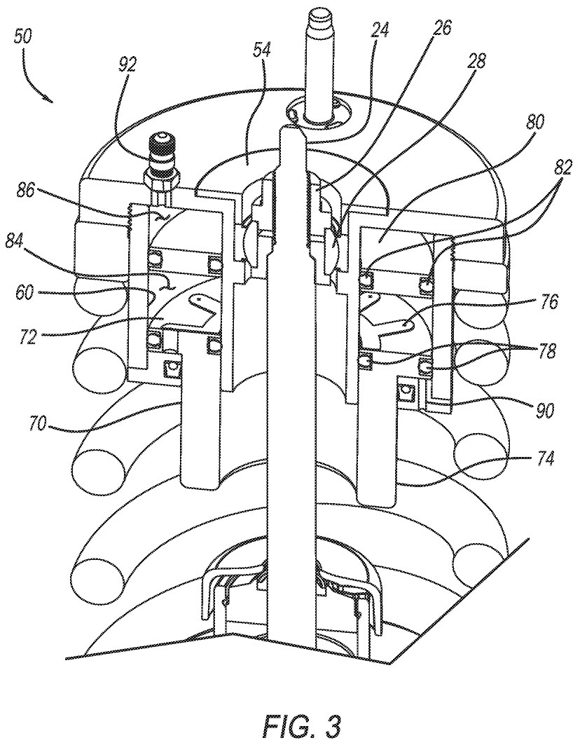

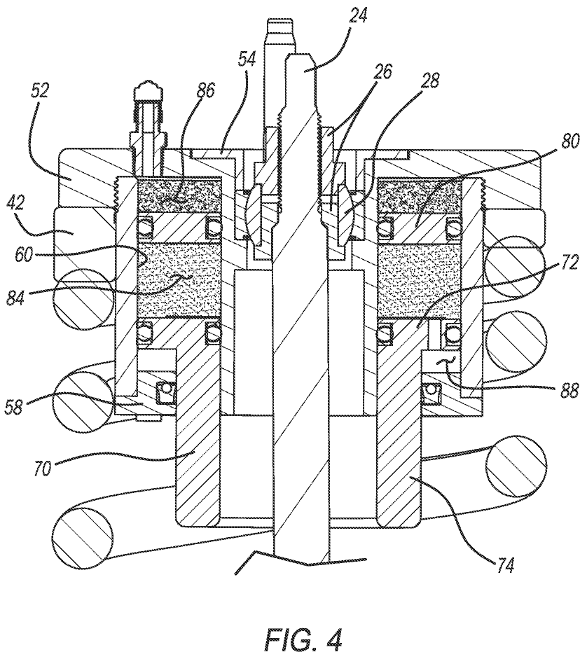

With continued reference to FIGS. 1 and 2, and additional reference to FIGS. 3 and 4, the jounce control damper 50 will now be described in additional detail. The jounce control damper 50 further includes a first jounce piston 70 seated in the jounce chamber 60 and extending out from within the jounce chamber 60. Specifically, the first jounce piston 70 includes a flange 72 seated within the jounce chamber 60. Extending from the flange 72 is a stem 74. The stem 74 extends through the bottom cap 58 and out of the jounce chamber 60. The flange 72 and the stem 74 are generally annular and surround the piston 22. The first jounce piston 70 is slidably seated within the jounce chamber 60 to allow the first jounce piston 70 to slide in a direction parallel to a length of the piston 22. The flange 72 defines a plurality of valves 76 configured to allow hydraulic fluid to flow therethrough as the first jounce piston 70 slides within the jounce chamber 60. The flange 72 further includes a seal 78 at both an outer diameter and an inner diameter of the flange 72 to restrict hydraulic fluid from flowing around the flange 72.

The jounce control damper 50 further includes a second jounce piston 80 seated within the jounce chamber 60 between the first jounce piston 70 and the top end of the jounce chamber 60. The second jounce piston 80 is a floating piston slidably movable within the jounce chamber 60 in a direction parallel to the length of the piston 22. The second jounce piston 80 is made of a solid material without openings or valves in order to prevent the flow of dampening fluid through the second jounce piston 80. Seals 82 are at an inner diameter and an outer diameter of the second jounce piston 80 to prevent dampening fluid from flowing around the second jounce piston 80. The first jounce piston 70, the second jounce piston 80, and the jounce chamber 60 all have an annular shape and extend around the piston 22.

The second jounce piston 80 divides the jounce chamber 60 into a first area 84 and a second area 86. The first area 84 is defined between the first jounce piston 70 and the second jounce piston 80. The second area 86 is defined between the second jounce piston 80 and the cup cap 52.

Within the first area 84 is a first damper fluid. Within the second area 86 is a second damper fluid. The first damper fluid and the second damper fluid may be any suitable fluids configured to damper movement of the first jounce piston 70 and the second jounce piston 80. For example, the first damper fluid may be any suitable hydraulic fluid, such as a hydraulic oil. The second damper fluid may be any suitable gas, such as nitrogen gas.

The first and second damper fluids may be added to the first area 84 and the second area 86 in any suitable manner. For example, the first damper fluid may be added to the first area 84 through a first fill port 90 (FIG. 3) defined by the bottom cap 58. The first fill port 90 is optional. In the absence of the first fill port 90, the first damper fluid may be added by detaching the bottom cap 58 and optionally removing the first jounce piston 70 to directly add the first damper fluid into the first area 84. The first jounce piston 70 may remain in place, and the first damper fluid may be added to the first area 84 through the valves 76. The second damper fluid may be added to the second area 86 through a second fill port 92 (FIG. 3) defined by the cup cap 52. To prevent the second jounce piston 80 from moving to the top end of the jounce chamber 60 as the first damper fluid is introduced into the first area 84, a support post may be inserted through the second fill port 90 to space the second jounce piston 80 apart from the cup cap 52 as the first damper fluid is introduced into the first area 84.

FIGS. 2 and 3 illustrate the jounce control damper 50 in a relaxed, uncompressed configuration. FIG. 4 illustrates the jounce control damper 50 in a generally compressed configuration. When the shock absorber assembly 10 is subject to shocks and vibrations sufficient to compress the shock absorber assembly 10 and move the first jounce piston 70 into contact with the cylinder 20, the first jounce piston 70 slides into the jounce chamber 60. Movement of the first jounce piston 70 into the jounce chamber 60 is dampened by the first damper fluid, which flows through the valves 76 as the flange 72 moves inward. The first damper fluid flows through the valves 76 into a third area 88 (FIG. 4) of the jounce chamber 60 defined between the flange 72 and the bottom cap 58 as a result of the flange 72 moving inward and away from the bottom cap 58. The flange 72 pushes the first damper fluid against the second jounce piston 80 to move the second jounce piston 80 towards the cup cap 52 and the top mount 32 of the shock absorber assembly 10. Movement of the second jounce piston 80 is dampened by the damper fluid in the second area 86.

The shock absorber assembly 10 thus includes the jounce control damper 50 integrated into the top mount 32 to provide hydraulic dampening of shocks and vibrations. The jounce control damper 50 is in line with the load path of the shock absorber assembly 10, which reduces load into the jounce control damper 50. By integrating the jounce control damper 50 into the shock absorber assembly 10, less bracketry and structure is required as compared to dampers that are mounted apart from a shock absorber assembly.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A shock absorber assembly comprising:
a cylinder housing a first damper fluid and a first piston, the first piston extending out from within the cylinder;
a top mount in cooperation with a distal end of the first piston; and
a hydraulic jounce control damper adjacent to the top mount, the hydraulic jounce control damper defining a jounce chamber including a second damper fluid and a second piston extending out from within the jounce chamber;
wherein in response to compression of the shock absorber assembly, the second piston is configured to contact the cylinder and slide within the jounce chamber with movement of the second piston dampened by the second damper fluid.

2. The shock absorber assembly of claim 1, wherein the shock absorber assembly is configured for installation in a vehicle.

3. The shock absorber assembly of claim 1, further comprising a spring extending around the hydraulic jounce control damper, the first piston, and the cylinder.

4. The shock absorber assembly of claim 1, wherein the second piston defines valve openings configured to allow the second damper fluid to flow therethrough.

5. The shock absorber assembly of claim 1, wherein the jounce chamber is annular and extends around the first piston.

6. The shock absorber assembly of claim 1, wherein the jounce chamber further includes a third piston slidably movable within the jounce chamber between the second piston and a top end of the jounce chamber.

7. The shock absorber assembly of claim 6, wherein:
the second damper fluid is within the jounce chamber between the second piston and the third piston; and
a third damper fluid is between the third piston and the top end of the jounce chamber.

8. The shock absorber assembly of claim 7, wherein the second damper fluid is a hydraulic fluid and the third damper fluid is a gas.

9. The shock absorber assembly of claim 7, wherein as the second piston slides within the jounce chamber in response to compression of the shock absorber assembly, the second piston pushes the second damper fluid against the third piston and moves the third piston towards the top end of the jounce chamber, movement of the third piston is dampened by the third damper fluid.

10. The shock absorber assembly of claim 9, wherein the third damper fluid is nitrogen gas.

11. The shock absorber assembly of claim 9, wherein the third piston is configured to restrict flow of the second damper fluid and the third damper fluid across the third piston.

12. A shock absorber assembly comprising:
a cylinder housing a first damper fluid and a first piston, the first piston extending out from within the cylinder;
a top mount in cooperation with a distal end of the first piston;
a hydraulic jounce control damper adjacent to the top mount and surrounding the first piston, the hydraulic jounce control damper defining a jounce chamber including a second piston extending out from within the jounce chamber and a third piston between the second piston and a top end of the jounce chamber, a hydraulic fluid is between the second piston and the third piston, and nitrogen gas is between the second piston and the top end of the jounce chamber; and
a spring extending around the hydraulic jounce control damper, the first piston, and the cylinder;
wherein in response to compression of the shock absorber assembly, the second piston is configured to contact the cylinder and slide within the jounce chamber to push the hydraulic fluid against the third piston to move the third piston towards the top end, movement of the second piston is dampened by the hydraulic fluid and movement of the third piston is dampened by the nitrogen gas.

13. The shock absorber assembly of claim 12, wherein the shock absorber assembly is configured for installation in a vehicle.

14. The shock absorber assembly of claim 12, wherein the second piston includes valve openings configured to allow the hydraulic fluid to flow therethrough.

15. The shock absorber assembly of claim 12, wherein each one of the jounce chamber, the second piston, and the third piston are annular-shaped and extend around the first piston.

16. A shock absorber assembly comprising:
a cylinder housing a first damper fluid and a first piston, the first piston extending out from within the cylinder;
a top mount in cooperation with a distal end of the first piston; and
a jounce control damper adjacent to the top mount, the jounce control damper including:
a housing defining a jounce chamber;
a second piston including a flange within the jounce chamber and a stem extending from the flange to an exterior of the jounce chamber, the flange defining a plurality of valves extending therethrough;
a third piston within the jounce chamber between the second piston and a top end of the jounce chamber;
a second damper fluid within a first area of the jounce chamber defined between the flange of second piston and the third piston; and
a third damper fluid within a second area of the jounce chamber defined between the third piston and the top end of the jounce chamber;
wherein:
in a relaxed configuration of the jounce control damper, the flange of the second piston is seated on a bottom of the jounce chamber; and
in a compressed configuration of the jounce control damper, the flange of the second piston has slid towards the third piston to push the first damper fluid against the third piston and move the third piston towards the top end of the jounce chamber, and the second damper fluid flows through the plurality of valves of the flange into a third area of the jounce chamber defined between the flange of the second piston and the bottom of the jounce chamber.

17. The shock absorber assembly of claim 16, wherein the second damper fluid is hydraulic fluid and the third damper fluid is nitrogen gas.

18. The shock absorber assembly of claim 16, wherein the shock absorber assembly is configured for installation in a vehicle.

19. The shock absorber assembly of claim 16, further comprising a spring extending around the jounce control damper, the first piston, and the cylinder.

20. The shock absorber assembly of claim 16, wherein each one of the jounce chamber, the second piston, and the third piston are annular-shaped and extend around the first piston.
